(19) United States
(12) Patent Application Publication
(10) Pub. No.: US 2017/0323691 A1
(43) Pub. Date: Nov. 9, 2017

(54) Nuclear fusion reactor using an array of conical plasma injectors

(71) Applicants: Richard Gorski, Arlington Heights, IL (US); Heinz Busta, Park Ridge, IL (US); Boris Rozansky, Skokie, IL (US); Hsing Yao Chen, Fox River Grove, IL (US)

(72) Inventors: Richard Gorski, Arlington Heights, IL (US); Heinz Busta, Park Ridge, IL (US); Boris Rozansky, Skokie, IL (US); Hsing Yao Chen, Fox River Grove, IL (US)

(21) Appl. No.: 14/998,763

(22) Filed: Feb. 10, 2016

(51) Int. Cl. G21B 1/15; G21B 1/21; G21B 1/17

(52) U.S. Cl. CPC G21B 1/15; G21B 1/17; G21B 1/21

(57) ABSTRACT

A nuclear fusion reactor includes a geodesic-shaped reaction chamber having at least j planar faces, where j equals 2, 6, 8, 12 or 20 and j conical plasma injectors (CPIs) for creating circular rings of neutral plasma. Each CPI includes a conical inner cathode electrode disposed coaxially within a hollow conical outer anode electrode, the space between the anode electrode and the cathode electrode forming a converging conical plasma channel for creating circular rings of neutral plasma, the converging conical plasma channel accelerating the plasma fuel into a converging plasma ring that comes to a focus at the center of the reaction chamber. The angle between axes of adjacent CPIs defines a CPI face angle, the angle defined by the converging conical plasma channel at its apex defining a CPI convergence angle, wherein the CPI convergence angle is approximately half the CPI face angle.

### BACKGROUND OF THE INVENTION

The invention relates generally to nuclear fusion reactors as a source of electric power and more particularly to a nuclear fusion reactor using an array of conical plasma injectors.

One of the most important resources needed in a modern industrialized society is an abundant source of electrical power. Currently most electrical power is generated by burning carbon dioxide generating fuels such as coal, oil and natural gas. The heat produced is used to generate steam which then is used to spin the turbines of electrical generators. Another source of heat is provided by nuclear fission reactors which has the huge downside of radioactive waste products and the potential for meltdown type disasters. A third source of electric power comes from solar energy in the form of solar cells, wind turbines and various forms of hydroelectric sources. These green sources however are at the mercy of weather conditions and some will only operate during daylight hours and thus are not consistent and reliable until adequate storage systems are developed. A fourth source of electric power comes from nuclear fusion. Nuclear fusion reactors are advantageous because of the ready availability of nuclear fuel (e.g., deuterium) and the lack of radioactive waste and inability to “melt down”. A fusion reactor operates by heating a gas to an extreme temperature of many millions of degrees. A gas at this temperature is known as plasma. Plasma, the fourth state of matter, is the condition where a gas is heated to a temperature such that negative electrons are stripped from atoms forming positively charged ions. Thus, plasma is a combination of positive ions along with an equal number of negatively charged free electrons. Since ions and electrons exist in about equal numbers the plasma is considered to be electrically neutral.

Building a practical fusion reactor (practical meaning one that produces more energy than it consumes) is difficult due to the extreme conditions of temperature, density and confinement time required for the fuel plasma to reach if excess energy is to be produced. This has been a challenge of physics for more than half a century. A successful fusion reactor would be fueled by the heavy isotopes of hydrogen known as deuterium and tritium. The heavy hydrogen isotope deuterium is readily found in seawater. A second isotope, tritium may also be used since the combination of tritium with deuterium as fuel will allow the reactor to operate at a lower plasma temperature. Tritium, although scarce on the Earth's surface is made within a fusion reactor itself as it is a byproduct of the fusion of deuterium with deuterium. Tritium can also be produced in a breeder setup within the reactor by fast neutron capture in a lithium blanket (fast neutrons are also produced in the deuterium-deuterium reaction).

It is well known that a fusion reactor cannot melt down due to the very small amount (milligrams) of gaseous fuel present in the reactor at any given time. In addition, a fusion reactor can be switched off with all fusion reactions ceasing. By comparison, a fission reactor which contains hundreds of tons of highly radioactive fuel cannot be switched off. The reaction rate in a fission reactor can only be slowed down to a rate that hopefully can be handled by the control systems and heat exchangers. In extreme cases system failure in a fission reactor can lead to a reactor meltdown situation.

The energy released in a fusion reaction is governed by the Einstein mass-energy equivalence relation E=Δmc² where Δm is the difference in mass between the sum of the two initial particles before fusion takes place and the smaller mass after the two incoming particles fuse creating a new heavier element. The new elements produced by the DD reaction (deuterium fusing with deuterium) are 50% tritium and 50% helium 3 with the emission of a fast neutron. The DT reaction (deuterium fusing with tritium) byproducts are helium 3 with the emission of a fast neutron. The DD reaction will produce a total of 1.2×10⁻¹² Joules of energy per reaction and the DT reaction produces 2.8×10⁻¹² Joules of energy per reaction. The products of fusion can be absorbed by surrounding the reactor vessel with proper thicknesses of a neutron absorbing material such as water or paraffin. Electrical energy will be generated utilizing the heat produced in the absorbing material to create steam which can be used to spin turbines connected to electrical generators.

The ability of a fusion power system to generate more energy than it consumes to heat the fuel plasma can be characterized by the Lawson criteria (eq. 1) that provides a measure of the plasma density and confinement time necessary for breakeven energy production (see J. D. Lawson, “Some Criteria for a Useful Thermonuclear Reactor”, A.E.R.E. report GP/R1807, (December 1955). Declassified Apr. 9, 1957). Generally, the Lawson criterion is given as the product of plasma density and confinement time for a specific plasma temperature:

$${nt}_{E} = \frac{12 k T}{〈 σ v 〉 {E}_{F}} = 1.4 \times {10}^{13} ( \frac{s}{{cm}^{3}} ) \qquad ( 1 )$$

where n=plasma density (1/cm³); <σv>=fusion cross section (4.2×10⁻¹⁶ cm³/s @20 keV); E_{F}=energy output per fusion reaction (2.8×10⁻¹²J); T=plasma temperature=20 keV (1.5×10⁸ K); t_{E}=confinement time (s); and k=Boltzmann constant (J/K).

From Equation (1), it can be seen that the Lawson product (nt_{E}) can be achieved either by using a very high plasma density with a very short confinement time or a low density plasma with a long confinement time. The type of fusion reactor having a short confinement time is known in the field as an inertial confinement reactor or ICR type. Reactors, such as the Tokomak, ITER project, International Thermonuclear Experimental Reactor, rely on plasma having the opposite characteristics: long confinement time (many seconds) with low density to achieve the Lawson criterion. The inertial confinement type of a reactor being tested at the National Ignition Facility (NIF) relies on laser induced compression and heating of a small frozen pellet (holoraum) of DT (deuterium fusing with tritium) fuel to create a plasma having a high plasma density and short confinement time. In the NIF reactor lasers provide the energy to heat a holoraum to create plasma to the required density and temperature.

Plasma injectors such as the plasma rail gun and the coaxial plasma gun have been used to create and accelerate plasmas for various applications. For example, a converging-barrel plasma accelerator is described in U.S. Pat. No. 3,579,028. The converging-barrel plasma accelerator described in U.S. Pat. No. 3,579,028 describes a conical plasma accelerator with a very shallow convergence angle of 5 degrees or less and uses a rod-like cathode electrode disposed within a vacuum envelope that extends to a target or window to enable evacuation of the plasma accelerator. Witherspoon et al. (see F. D. Witherspoon et al., “Mini Rail gun Accelerator for Plasma Liner Driven HEDP and Magneto-Inertial Fusion Experiment”, HyperV Technologies Corp., Talk presented at the 36^{th} ICOPS Meeting, San Diego, Calif., (June 2009) and J. W. Mather,” Formation of a High-Density Deuterium Plasma Focus”, The Physics of Fluids, vol. 8, pp. 366-377 (February 1965).) have also experimented with rail gun technology. Experimental data from rail gun tests have shown that rail gun technology, through a variety of plasma accelerator configurations, can create the intense plasma burst at the high-velocity and density needed for fusion. These various technologies rely on small convergence angles in the plasma accelerator; indirect heating through use of a high atomic mass gas such as xenon; or use of ion beams and none has been able to achieve breakeven energy production.

### BRIEF SUMMARY OF THE INVENTION

A nuclear fusion reactor according to the invention includes a geodesic-shaped reaction chamber having at least j planar faces, where j=2; at least j conical plasma injectors (CPIs) for creating circular rings of electrically neutral plasma, accelerating the plasma to high velocity and focusing the plasma rings at the center of the reaction chamber, the conical plasma injectors being arranged symmetrically about the reaction chamber and aimed at the convergence point at the center of the reaction chamber. Each CPI is mounted at a face of the reaction chamber and aimed parallel to and centered upon an imaginary vector normal to the face it is mounted on, wherein the normal vector is the axis of the conical plasma injector such that all conical plasma injector axes meet at the center of the reaction chamber. Each CPI includes a conical inner cathode electrode disposed coaxially within a hollow conical outer anode electrode forming a space there between, the space between the anode electrode and the cathode electrode forming a converging conical plasma channel for creating circular rings of neutral plasma, the converging conical plasma channel accelerating the plasma fuel into a converging plasma ring that comes to a focus at the center of the reaction chamber. An insulator engages the outer anode electrode at the large end thereof and mounts the inner cathode electrode, the insulator having an opening for providing neutral fusion fuel to the converging conical plasma channel. The angle between axes of adjacent CPIs defines a CPI face angle, the angle defined by the converging conical plasma channel at its apex defining a CPI convergence angle, wherein the CPI convergence angle is approximately half the CPI face angle, the CPI convergence angle imparting inward motion to the plasma accelerating and focusing it. A high voltage power supply provides energy input for generating an arc discharge and creating a plasma in the conical plasma channel at the large end of each CPI. A valve connects a source of neutral fusion fuel to each CPI for providing neutral fusion fuel at each CPI. A vacuum pump is coupled to the reaction chamber for creating a vacuum at a defined pressure, maintaining the vacuum at the defined pressure and for removing exhaust products.

The nuclear fusion reactor according to the invention provides symmetrical compression and heating of hydrogen plasma to the density and temperature required for nuclear fusion for use in producing electrical power. An imploding spherical shell of hot plasma is generated by a symmetrical arrangement of conical plasma injectors configured such that the focal point of each conical plasma injector is coincident at the center of the reaction chamber. Each conical plasma injector fires an intense, hyper velocity pulse of neutral plasma in the form of a collapsing ring that reaches minimum size and maximum density at the center of the reaction chamber. The conical plasma injectors are arranged in accordance with geodesic shapes so that the conical plasma injectors are equally spaced in position and angle such that the merging of all plasma rings achieves uniform compression and ignition. In addition to achieving sustained nuclear fusion, the apparatus can also be utilized for neutron and tritium generation.

The nuclear fusion reactor according to the invention creates a spherical deuterium/deuterium or deuterium/tritium plasma having a temperature of 20 keV (150 million Kelvin). In order to create more energy than is consumed in the reactor, the reactor must satisfy the Lawson criteria, that is, the reactor must generate a 20 keV plasma temperature, where the plasma density times the confinement time must be greater than 1.4×10¹³ (s/cm³). Confinement is defined as the period of time that the plasma is confined within a sphere of radius R constrained by its own inertia. This is generally thought to be equivalent to the speed of sound in the plasma which can be estimated by equation (2) below:

$${t}_{E} = \frac{R}{{( k T \text{/} m )}^{1 / 2}} ( s ) \qquad ( 2 )$$

where, R—radius of plasma, T—plasma temperature=20 keV (1.5×10⁸ K), t_{E}=confinement time (s), k=Boltzmann constant (J/K) and m=average mass of particles.

Substituting equation (2) for confinement time, t_{E}, into the Lawson equation (1) and solving for the density n yields equation (3) below that predicts the plasma density as a function of the spherical plasma radius R needed to achieve breakeven energy production.

$$n = \frac{12 {( k T )}^{3 / 2}}{R 〈 σ v 〉 {E}_{F} \sqrt{m}} ( \frac{1}{{cm}^{3}} ) \qquad ( 3 )$$

A plot of equation (3) for T=plasma temperature=20 keV operation is shown in FIG. 1.

Referring to FIG. 1, the plot shown provides the physical parameters that the plasma must reach if the energy output is to be greater than the energy input used to heat the plasma. Thus for a reactor operating point of T=20 keV and referring to FIG. 1, we identify operating conditions given below:
Plasma density n of at least 5×10²⁰ (1/cm³)
Plasma radius=1.0 cm.
Plasma confinement time=2.0×10⁻⁸ seconds (from eq. 2)
Plasma temperature=20 keV (150 million degrees K)
   A characteristic of this plasma is that the Lawson product (nt_{E}) is achieved by using a very high plasma density with a very short confinement time. This allows for a practical reactor to be constructed using conical plasma injectors described herein.

In the present invention the hot dense plasma is created by firing very intense bursts of high velocity electrically neutral fuel plasma from at least two conical plasma injectors(CPIs) into the center of a reaction chamber. Each CPI creates a plasma ring and the plasma rings from all CPIs converge into a centimeter sized (from FIG. 1) spherical ball causing compression and heating to the required temperature and density needed for fusion reactions to occur. To achieve fusion reactions, the plasma velocity needed is 1×10⁶ m/s, which is equivalent to the average velocity of molecules in a gas at a temperature of 20 keV or 150 million K.

The conical plasma injectors are arranged in a symmetrical fashion around the reaction chamber and aimed at the convergence point at the reactor center. Each CPI will generate a converging ring of electrically neutral plasma consisting of 1×10²⁰ particles, accelerate them to near 1×10⁶ m/s velocity and direct and focus them toward the center convergence point inside the reaction chamber. When all plasma rings have converged at the center of the reaction chamber, the density will increase to approximately 6×10²⁰ per cubic centimeter and will have thermalized to reach a temperature of about 20 keV. Due to its own inertia the resulting spherical plasma will be confined within a diameter of about 2 cm for a time period of about 20 nanoseconds. During this time period thermonuclear ignition will occur yielding an energy output that surpasses the energy input used to accelerate and heat the plasma.

The conical plasma injectors create the circular rings of neutral plasma, accelerate the plasma to high velocity and focus the plasma rings at the center of the reaction chamber. The plasma must be electrically neutral so that electrical repulsion between particles (space charge repulsion) does not occur. The CPI operates on the similar principle used in rail gun technology where an intense high voltage discharge of electrical current ionizes a gas at the breech (the large end) of the rail gun. Then due to the magnetic field generated by the discharge current the charged particles in the plasma are accelerated by the Lorentz force in the same direction and away from the breech of the rail gun to be ejected out of the muzzle (the small end) of the rail gun. Focusing of the plasma ring happens due to the converging orientation of the plasma channel.

The nuclear reactor according to the invention employs an array of conical plasma injectors, each of which has a large convergence angle, and uses electrically neutral plasma fuel. The large convergence angle of the CPI imparts an inward motion to the plasma as it exits the small or ejection end (the “muzzle”) of each CPI providing a focusing effect as well as accelerating and directly heating the plasma fuel to a high velocity. The angle of the conical accelerating plasma channel is such that a projection of the cone angle forward into the reaction chamber coincides with the center (focal point) of the chamber. The apex projection from all CPIs in the reactor coincides with the focal point of the reaction chamber. Ejection velocity and plasma density are determined from various physical and electrical parameters of the CPI (and number of CPIs) used in the particular embodiment of nuclear reactor according to the invention. The nuclear reactor according to the invention achieves sufficient plasma heating and compression directly, without use of another gas for heating (such as xenon) by imparting the energy equivalent to 20 keV to the plasma during the acceleration phase and then achieving compression of the plasma by virtue of the plasma's own inertia in the form of a collapsing spherical shell.

### BRIEF DESCRIPTION OF THE SEVERAL VIEWS OF THE DRAWINGS

FIG. 1 is a chart depicting the plasma density required for breakeven energy production as a function of the plasma radius for the DT reaction and a plasma temperature of 20 keV.

FIG. 2 is cross section of a nuclear fusion reactor according to the invention having two CPIs.

FIG. 3 is a cross section of a nuclear fusion reactor according to the invention having six CPIs, with four shown in the cross section.

FIG. 4 is a conceptual illustration of a nuclear fusion reactor according to the invention having twelve CPIs.

### DETAILED DESCRIPTION OF THE INVENTION

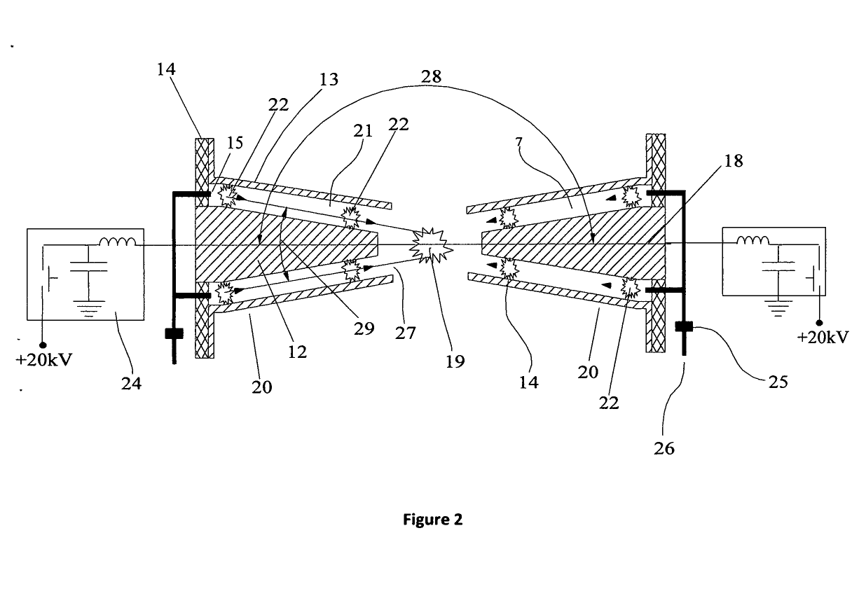

Referring to FIG. 2, a cross-section of a nuclear reactor having two CPIs 20 according to the invention is shown. In order to have a symmetrical and spherical imploding plasma shell, the number, physical placement, angular placement and converging angle of the plasma channel in the CPIs are arranged symmetrically about the geodesic-shaped reaction chamber (not shown) and aimed at the convergence point 19 at the center of the reaction chamber. In FIG. 2, the reactor has two CPIs, one each attached to the two planar faces of the reaction chamber. Each CPI20 is mounted at a face of the reaction chamber and aimed parallel to and centered upon an imaginary vector 18 normal to the face it is mounted on, wherein the normal vector 18 is the axis of the CPI such that all CPI axes meet at the center 19 of the reaction chamber. Each CPI20 includes a conical inner cathode electrode 12 disposed coaxially within a hollow conical outer anode electrode 13 forming a space 21 there between, the space 21 between the anode electrode 13 and the cathode electrode 12 forming a converging conical plasma channel 21 for creating circular rings of neutral plasma 22, the converging conical plasma channel 21 accelerating the plasma fuel 22 into a converging plasma ring that comes to a focus at the center 19 of the reaction chamber. Each CPI 20 includes an insulator 14 engaging the outer anode electrode 13 at the large end thereof (the “breech”) and mounting the inner cathode electrode 12, the insulator 14 having an opening 15 for providing neutral fusion fuel to the converging conical plasma channel. The angle between axes of adjacent CPIs defines a CPI face angle 28, the angle defined by the converging conical plasma channel 21 at its apex defines a CPI convergence angle 29, wherein the CPI convergence angle 29 is approximately half the CPI face angle 28, the CPI convergence angle 29 imparts inward motion to the plasma 22 accelerating and focusing it. A high voltage power supply 24, which in this embodiment is a bank of capacitors, provides energy input for generating an arc discharge and creating a plasma in the conical plasma channel 21 at the large end of each CPI 20. A source of electrically neutral fusion fuel 26 is provided to each valve 25 for connecting the fusion fuel to each CPI 20 for providing electrically neutral fusion fuel at each CPI 20. A vacuum pump (not shown) is coupled to the reaction chamber (not shown) for creating a vacuum at a defined pressure, maintaining the vacuum at the defined pressure and for removing exhaust products.

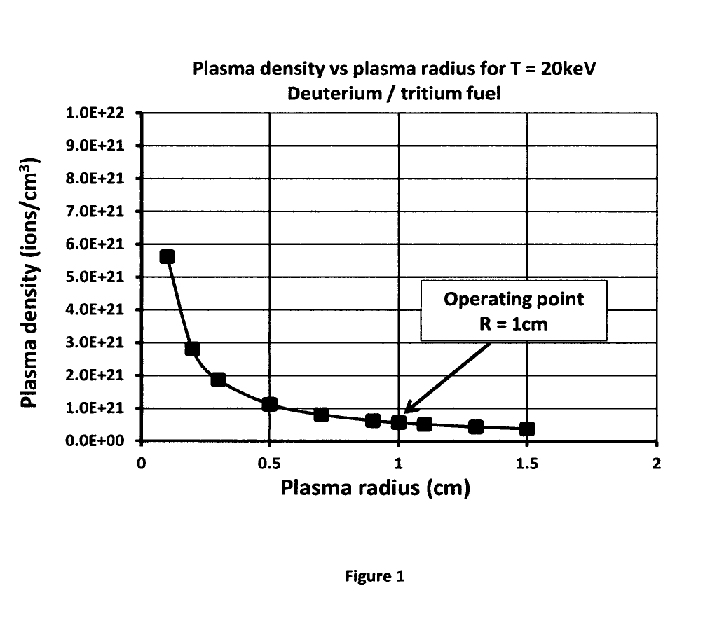

Cathode 12 may be formed of a suitable conductor, such as tungsten, with outer anode formed of aluminum. The spacing between the inner cathode 12 and outer anode 13 does not have to be constant. There may be reasons for the channel 21 to widen or narrow to get the best performance. When the plasma 22 exits the channel 21 into the vacuum space it will form as a torus about 1 cm in thickness (using the point identified in FIG. 1). The plasma 22 will expand somewhat on its way to the convergence point 19. In this embodiment, 1 cm was chosen as a reasonable starting point so that the gas ionizes completely based on the pressure and applied potential difference. Too large a gap means that the gas will not ionize. Too small and there is not enough gas present to reach the density required at the convergence point. Adjacent CPI 20 muzzle 27 are separated far enough so they do not affect each other.

Table 1 shows the various dimensions of other embodiments of the invention based on other geodesic shapes. In order to have a symmetrical and spherical imploding plasma shell the number, physical placement, angular placement and CPI convergence angle 29 should be according to table 1 based on geodesic shapes and CPI face angle 28. The radius of the plasma channel 21 at the breech (insulator 14) of each CPI 20 in all embodiments was determined so that at a pressure of 0.5 Torr, there are just enough gas molecules present in the volume at the breech from all the CPIs 20 in the particular geodesic shape of the reactor vessel such that when all plasmas 22 combined at the convergence point 19, a density of about 5×10²⁰ particles/cm³ is achieved. This volume assumes a plasma ring has a 1 cm×1 cm cross section and a circumference determine by the radius (2πR). This determines the radius at the breech.

The speed of the plasma 22 is mainly controlled by the energy contained in the capacitive discharge created by power supply 24, which determines the arc current and the accelerating magnetic field. Speed is also determined by physical parameters of the plasma channel 21 such as length and gap. For highest velocity we need to electronically match the discharge so that all the capacitor energy is dumped into the plasma 22 while still accelerating within the CPI channel 21. Highest velocity should occur when the entire length of the plasma channel 21 is used to accelerate the plasma 22. Too short a discharge time is too explosive and too long a discharge time means that not all the capacitor energy was used. The CPI convergence angle 29 must be half the angular separation between the normal vectors of the faces of the geodesic chamber, the CPI face angle. This relationship guarantees that the plasma channels 21 of adjacent CPIs will be equally spaced both in angle and position around the inside of the geodesic-shaped reactor vessel, thus forming a uniform converging plasma shell. Knowing the CPI radius and CPI convergence angle 29, we can then determine the distance to the convergence point 19 which determines the basic radius of the reaction chamber (distance from the beginning of the plasma channel 21 to the center 19). For convenience, the length of the CPI 20 is defined as approximately half of the radius of the reactor chamber. In Table 1, CPI face angle in degrees is the angle between the axes of adjacent CPIs. CPI face angle is also the angle between the normal vector of two adjacent geodesic faces. The CPI convergence angle in degrees is the full angle of the plasma channel in a CPI. The CPI radius in centimeters, is the radius of the plasma channel at the breech of the CPI. The value is determined so that 0.5 Torr gas pressure in the start of the breech yields the correct number of gas molecules to achieve focal point plasma density.

TABLE 1

| | | | CPI | CPI | | Reactor |
|---|---|---|---|---|---|---|
| Reactor | | CPI Face | Convergence | Radius at | CPI | Vessel |
| Vessel | Number | Angle | Angle | Breech | Length | Diameter |
| Shape | of Faces | (degrees) | (degrees) | (cm) | (cm) | (cm) |
| Double Plane | 2 | 180.00 | 90.00 | 105.94 | 52 9 | 211.6 |
| Cube | 6 | 90.00 | 45.00 | 35.31 | 42.6 | 170.4 |
| Octahedron | 8 | 70.53 | 35.27 | 26.50 | 37.0 | 147 0 |
| Dodecahedron | 12 | 63.43 | 31.72 | 17.70 | 31.1 | 124.4 |
| Isocohedron | 20 | 41.81 | 20.91 | 10.59 | 28.7 | 114.8 |

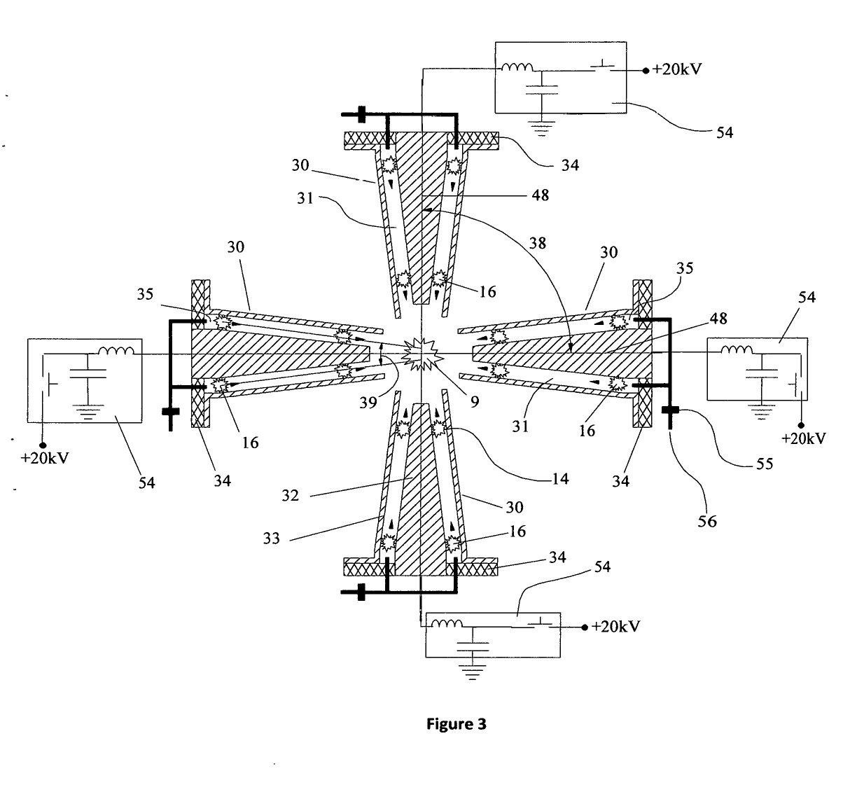

Referring to FIG. 3, a cross section of a nuclear fusion reactor using the cubic form, i.e., one which employs six CPIs 30 is shown. In FIG. 3 the cross section through one plane shows four of the six CPIs 30 in a cubic-shaped geodesic dome reactor vessel. Two additional CPIs 30 would exist in and out of the plane of the paper forming a symmetrical arrangement of CPIs. As shown in FIG. 3, the gap between smaller inner cathode electrode 32 and the larger outer anode electrode 33 form a conical plasma channel 31. Each CPI30 is mounted at a face of the reaction chamber and aimed parallel to and centered upon an imaginary vector 48 normal to the face it is mounted on, wherein the normal vector 48 is the axis of the CPI 30 such that all CPI axes meet at the center 9 of the reaction chamber. Each CPI 30 includes a conical inner cathode electrode 32 disposed coaxially within a hollow conical outer anode electrode 33 forming a space 31 there between, the space 31 between the anode electrode 33 and the cathode electrode 32 forming a converging conical plasma channel 31 for creating circular rings of neutral plasma 16, the converging conical plasma channel 31 accelerating the plasma fuel from source 56 into a converging plasma ring 16 that comes to a focus at the center 9 of the reaction chamber. Each CPI 30 includes an insulator 34 engaging the outer anode electrode 33 at the large end thereof (the “breech”) and mounting the inner cathode electrode 32, the insulator 34 having an opening 35 for providing neutral fusion fuel to the converging conical plasma channel. In order for the emitted plasma rings 16 from each of the six CPIs 30 to be aimed at the reactor focal point 9 and also be symmetrically spaced around the reactor vessel cube the angle between the axes (CPI face angle 38) of adjacent plasma injectors 30 must be 90.00 degrees. Geometry dictates that the CPI convergence angle 39 of the plasma channel must be correspondingly one half the angle between CPIs axes or 45.00 degrees. This is to provide equal angular spacing between the plasma channels of adjacent CPIs. The CPI convergence angle 39 also provides a projection of the conical plasma channel 31 forward into the reaction chamber that converges to a point coincident with the reactor vessel center 9. In this way the converging plasma rings 16 will come to a focus at the reactor focal point. A high voltage power supply 54, which in this embodiment is a bank of capacitors, provides energy input for generating an arc discharge and creating a plasma in the conical plasma channel 31 at the large end of each CPI 30. A source of electrically neutral fusion fuel 56 is provided to each valve 55 for connecting the fusion fuel to each CPI 30 for providing electrically neutral fusion fuel at each CPI 30. A vacuum pump (not shown) is coupled to the reaction chamber (not shown) for creating a vacuum at a defined pressure, maintaining the vacuum at the defined pressure and for removing exhaust products.

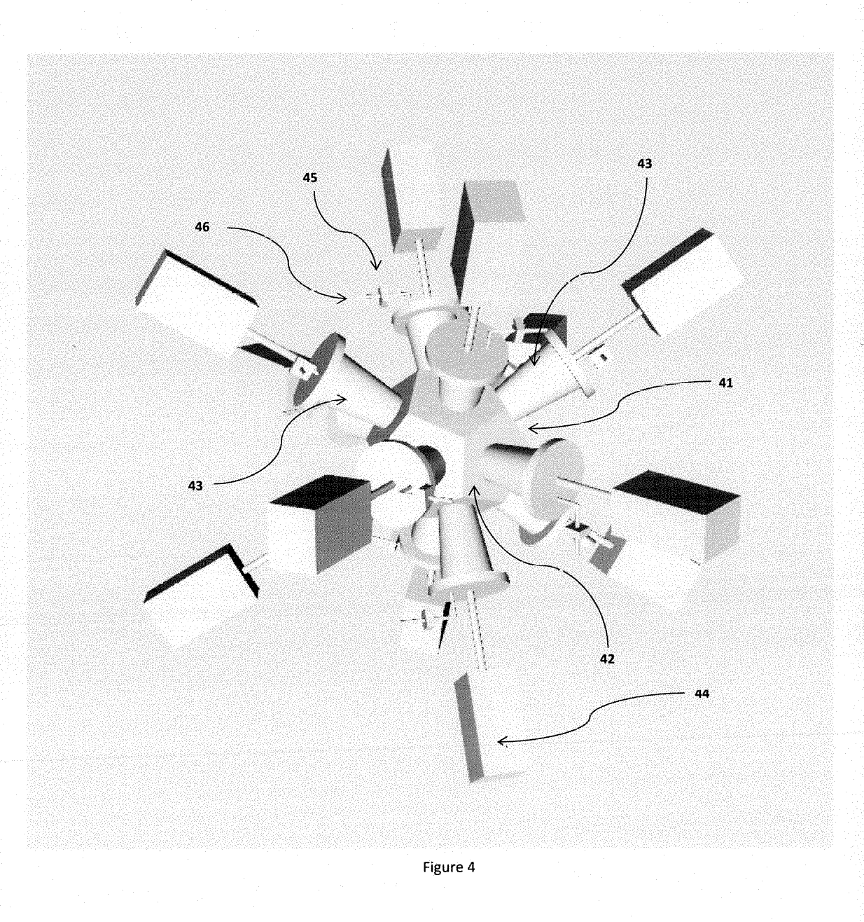

Referring to FIG. 4, a nuclear fusion reactor according to the invention employing a dodecahedron geodesic configuration is shown in schematic form. Twelve CPIs 43 are shown equidistant from the center of the dodecahedron reaction vessel 41 and placed symmetrically in position and angle around the reaction vessel 41. Reactor vessel 41 is a twelve sided three dimensional shape where the flat faces 42 of each side have identical dimensions. In FIG. 4, twelve conical plasma injectors 43 are mounted about the reaction vessel, one at each face. The twelve plasma injectors 43 reside at the center of each of the twelve faces 42 and each CPI 43 is aimed parallel to and centered on the imaginary vector normal to the face it is mounted on. The normal vector is the axis for each of the CPIs and all CPI axes meet at the center of the reactor chamber 41. Attached to each CPI 43 is a capacitor bank 44 used to supply electrical energy to the CPI 43 and a fast acting valve 45 used to momentarily allow fuel gas (not shown) into the breech end of the CPI 43. The fast acting gas valve 45 could be a single device or an array of devices fabricated using MEMS (Micro Electro Mechanical Systems) technology which can provide microsecond activation due to the low mass of the actuating lever. The gas supply line is shown as item 46. The plasma rings (not shown) generated by each CPI 43 travel along the channels in each CPI, directionally along the axis of each CPI and converge at the center of the dodecahedron vacuum vessel. The reactor vessel 41 in FIG. 4 is shown as a solid dodecahedron where the twelve solid faces are used to mount the CPIs 43 however the CPI mounting structure could also be an open frame and the actual vacuum vessel much larger, surrounding the open frame.

In the embodiment of FIG. 4 using the dodecahedron shaped reactor vessel, the corresponding CPI face angle and CPI convergence angle would be as given in Table 1 or 63.43 degrees and 31.72 degrees respectively. In this embodiment using the dodecahedron the channel radius is 17.7 cm at the breech end and tapers down to a channel radius of 8.9 cm at the muzzle end with a total length of about 31.1 cm. The plasma will be created at the breech by an arc discharge from a high voltage capacitor bank 44 occurring at the breech in the channel formed between the inner cathode electrode and outer anode electrode of each of the twelve CPIs 43. Initially the plasma channel is under high vacuum such that the channel can withstand about 20 kV without electrical breakdown. Next a putt of deuterium or tritium fuel gas from a fast acting valve 45 enters the breech of the CPI through holes or a channel near the breech. Then due to Paschen's law an intense capacitive discharge current of many thousands of amperes occurs through the fuel gas.

Paschen's law states that electrical breakdown of a gas suddenly occurs when the gas pressure reaches a level determined by the voltage present, the physical gap dimensions and the gas pressure. When the discharge occurs the gas will quickly ionize forming a conductive ring through which the large discharge current will pass from the inner electrode to the outer electrode. In this embodiment, the gas pressure at discharge will be 0.5 Torr or greater which means that sufficient gas molecules are present in the channel so that the required plasma density can be reached. In addition the capacitive voltage at the onset of gas breakdown should be about 20 kV to guarantee sufficient plasma exit velocity.

Alternatively, each CPI can be fired without need for the fast acting gas valve. In this method a constant gas pressure of 0.5 Torr is maintained in the plasma channel and then by use of a high voltage high current electronic switch the capacitive charge is dumped through the gas causing ionization. The intense electrical current passing through the ionized gas (plasma) creates a very strong toroidal magnetic field of several Tesla. Since both electrons and ions are moving across the gap the Lorenz force accelerates the plasma ring down the CPI plasma channel exiting at high-velocity. Due to the converging circular cross section of the CPI plasma channel the plasma forms into a ring which becomes smaller in radius as it travels down the CPI plasma channel towards the center of the reactor. In addition the discharge current increases in intensity as the cross sectional area of the ring decreases further increasing the acceleration force such that the plasma reaches a final exit velocity of around 10⁶ m/s. This exit velocity is equivalent to the average velocity of molecules in a gas at a temperature of some 150 million Kelvin. Upon emergence from the CPI muzzle aperture the plasma ring continues along its trajectory and reaches maximum density at the reaction chamber center. All plasma rings created by all the CPIs in the reactor vessel converge at the center of the reactor momentarily forming a 2 centimeter diameter dense hot sphere of plasma. Based on the velocity of the plasma at the focal point the density of the plasma will increase to the desired 6×10²⁰ particles/cm³ and last at that density for a time period of about 20 nanoseconds. In addition the pressure will have increased to several tens of atmospheres resulting in a complete thermalization of the plasma meaning that while the plasma is within the 2 cm diameter sphere there will be prolific random scattering of particles resulting in a thermal distribution of velocity and energy corresponding to 20 keV temperature. Thus nuclear ignition will occur.

Focusing of the plasma ring occurs due to the converging orientation of the CPI plasma channel and by the magnetic self-converging forces that occur when the plasma leaves the muzzle. The firing sequence of the system of CPIs must be timed precisely or the plasma shell may not collapse symmetrically resulting in low plasma density. Firing of each CPI may be controlled by a fast electrical pulse that will momentarily open the fast acting gas valve for a time period that allows the proper gas pressure to build in the breech of the CPI until capacitor discharge occurs. After each firing the capacitor banks will be recharged and ready for the next firing. Based on the expected rate of fusion for the DT reaction the fusion energy produced will be 7.5×10⁶ Joules per pulse and if the reactor pulses at the rate of once per second the reactor will be create 7.5×10⁶ Watts of power which is equal to the energy input needed to accelerate and heat the plasma. Thus any increase in density or confinement time will result in the production of excess energy that can be sent to the electrical grid.

If the nuclear fuel is to be a 50/50 mix of tritium and deuterium, halt of the CPIs in a nuclear fusion reactor according to the invention will fire tritium and the remaining half will fire deuterium. Injection of different fuels from different CPIs is necessary due to the difference in mass of the two fuel particles and the fact that they will accelerate at different rates and arrive at the focal point of the reaction chamber at different times. Thus the heavier fuel (tritium) be fired first from the tritium CPIs followed by firing of the deuterium CPIs several tenths of microseconds later. Thus all fuel components will arrive at the reactor focal point at the same time. Another method to handle the difference in mass between the tritium fuel and deuterium would be to fire all CPIs simultaneously but design the electrical and geometric parameters of the deuterium and tritium CPIs independently to effectively adjust the plasma exit velocity so that both fuel sources arrive at the focal point at the same time. If the nuclear fuel is to be 100% deuterium then all CPIs will fire simultaneously but the required plasma density and temperature must be correspondingly higher to achieve breakeven energy production due to the lower fusion probability (fusion cross section) when deuterium fuses with deuterium.

Another possible fusion fuel mixture is Boron¹¹ fusion with hydrogen(B¹¹-p). This fuel has the advantage of producing only charged Helium⁴ as a byproduct (no neutrons). The high energy charged particles are easier to capture in the absorbing media for conversion of their energy to heat. However the drawback is that a much higher temperature would be required for a successful B¹¹-p fusion reactor.

Larger and smaller versions of the nuclear fusion reactor of the invention may be built. For example scaling the dimensions of the dodecahedron embodiment by one-fifth would result in a smaller, less powerful reactor capable of producing a 0.2 cm radius plasma sphere of the required density and temperature for fusion to occur. The plasma channel in the one-fifth scaled CPI would be 0.2 cm wide, which can still support the 20 kV potential needed to create the 1×10⁶ m/s plasma exit velocity. Dimensions of such a one-fifth scaled reactor based on the dodecahedron would be as follows:
CPI axis-axis angle=63.43 degrees.
CPI convergence angle=31.72 degrees
CPI radius at breech=3.54 cm
CPI length=6.22 cm
Plasma channel width=0.2 cm
Dodecahedron diameter=24.88 cm

A nuclear reactor according to the invention provides a means for compressing and heating a hydrogen fuel gas to the temperature and density required such that prolific fusion reaction within the heated fuel gas takes place and are numerous enough so that excess energy is produced. A nuclear reactor according to the invention employs multiple CPIs symmetrically arranged around a geodesic-shaped reactor vessel such that all CPIs are equally spaced from each other and aimed such that the imaginary axis of all CPIs meet at the center of the reaction chamber. A nuclear reactor according to the invention provides CPIs that contain a converging conical plasma charnel, formed by a conical inner cathode electrode and conical outer anode electrode that forces the fuel plasma into an accelerating and converging ring and comes to a focus at the center of the reaction chamber. The capacitive discharge used to initially form the reaction can be initiated by a sudden increase in gas pressure from high vacuum or initiated by dumping the capacitive charge using an electronic switch with the CPI immersed in a constant gas pressure of about 0.5 Torr. A nuclear reactor according to the invention provides CPIs for producing and accelerating neutral fuel plasma to near 1×10⁶ m/s velocity and come to a focal point with a particle density of 5×10²⁰ per cm³. A fast acting gas valve that allows the pressure at the breech of the CPI to go from deep vacuum to about 0.5 Torr in 1 microsecond may be used. In addition the CPI convergence angle can also be adjusted to compensate for any magnetic focusing effects that have not been anticipated.

Although the present invention has been described and illustrated with respect to identified embodiments, it is not intended to limit the invention to the details of illustration or particular terms of description. Reference is made to the appended claims for a precise delineation of the scope of the invention.

What is claimed is:

1) A nuclear fusion reactor comprising:
a geodesic-shaped reaction chamber having at least j planar faces, where j=2;
at least j conical plasma injectors (CPIs) for creating circular rings of electrically neutral plasma, accelerating the plasma to high velocity and focusing the plasma rings at the center of the reaction chamber, the CPIs being arranged symmetrically about the reaction chamber and aimed at the convergence point at the center of the reaction chamber,
each CPI mounted at a face of the reaction chamber and aimed parallel to and centered upon an imaginary vector normal to the face it is mounted on, wherein the normal vector is the axis of the CPI such that all CPI axes meet at the center of the reaction chamber,
each CPI including a conical inner cathode electrode disposed coaxially within a hollow conical outer anode electrode forming a space there between, the space between the anode electrode and the cathode electrode forming a converging conical plasma channel for creating circular rings of neutral plasma, the converging conical plasma channel accelerating the plasma fuel into a converging plasma ring that comes to a focus at the center of the reaction chamber, an insulator engaging the outer anode electrode at the large end thereof and mounting the inner cathode electrode, the insulator having an opening for providing neutral fusion fuel to the converging conical plasma channel,
the angle between axes of adjacent CPIs defining a CPI face angle, the angle defined by the converging conical plasma channel at its apex defining a CPI convergence angle, wherein the CPI convergence angle is approximately half the CPI face angle, the CPI convergence angle imparting inward motion to the plasma accelerating and focusing it;
a high voltage power supply for energy input for generating an arc discharge and creating a plasma in the conical plasma channel at the large end of each CPI;
a source of electrically neutral fusion fuel;
a valve for connecting the source of fusion fuel to each CPI for providing electrically neutral fusion fuel at each CPI; and
a vacuum pump coupled to the reaction chamber for creating a vacuum at a defined pressure, maintaining the vacuum at the defined pressure and for removing exhaust products.

2. The nuclear fusion reactor of claim 1, wherein the source of fusion fuel comprises deuterium.

3. The nuclear fusion reactor of claim 1, wherein the source of fusion fuel comprises equal portions of deuterium and tritium fuel, wherein deuterium fuel is provided to half of the conical plasma injectors and tritium is provided to the remaining half of the conical plasma injectors.

4. The nuclear fusion reactor of claim 1 wherein j=6.

5. The nuclear fusion reactor of claim 1 wherein j=8.

6. The nuclear fusion reactor of claim 1 wherein j=12.

7. The nuclear fusion reactor of claim 1, where j=20.

8. The nuclear fusion reactor of claim 1, wherein the high voltage power supply comprises j capacitor banks.

9. The nuclear fusion reactor of claim 3, further comprising a timing circuit for firing the conical plasma injectors receiving tritium before firing the CPIs receiving deuterium, such that all tritium receiving CPIs are fired simultaneously and all deuterium receiving CPIs are fired simultaneously.

10. The nuclear fusion reactor of claim 1, wherein the CPI face angle is approximately 180 degrees, the CPI convergence angle is approximately 90 degrees, the radius of the conical outer anode electrode is approximately 106 cm, the length of the conical plasma injector axis is approximately 53 cm.

11. The nuclear fusion reactor of claim 4, wherein the CPI face angle is approximately 90 degrees, the CPI convergence angle is approximately 45 degrees, the radius of the conical outer anode electrode is approximately 35 cm, the length of the conical plasma injector axis is approximately 43 cm.

13. The nuclear fusion reactor of claim 5, wherein the CPI face angle is approximately 71 degrees, the CPI convergence angle is approximately 35 degrees, the radius of the conical outer anode electrode is approximately 26 cm, the length of the conical plasma injector axis is approximately 37 cm.

14. The nuclear fusion reactor of claim 6, wherein the CPI face angle is approximately 63 degrees, the CPI convergence angle is approximately 32 degrees, the radius of the conical outer anode electrode is approximately 18 cm, the length of the conical plasma injector axis is approximately 32 cm.

15. The nuclear fusion reactor of claim 7, wherein the CPI face angle is approximately 42 degrees, the CPI convergence angle is approximately 21 degrees, the radius of the conical outer anode electrode is approximately 11 cm, the length of the conical plasma injector axis is approximately 28 cm.

16. The nuclear fusion reactor of claim 1, wherein the space between the anode electrode and the cathode electrode, has a constant distance at each point between the anode electrode and cathode electrode.

17. The nuclear fusion reactor of claim 1, wherein the distance at each point between the anode electrode and the cathode electrode is approximately 1 cm at the small end thereof.
